(19) United States
(12) Patent Application Publication
(10) Pub. No.: US 2021/0235529 A1
(43) Pub. Date: Jul. 29, 2021

(54) Communication Method for Mobile Terminal, Mobile Terminal, Medium and Apparatus

(71) Applicant: Gree Electric Appliances, Inc. of Zhuhai, Zhuhai, Guangdong (CN)

(72) Inventor: Jia LI, Zhuhai, Guangdong (CN)

(21) Appl. No.: 17/050,294

(22) PCT Filed: Dec. 25, 2018
(86) PCT No.: PCT/CN2018/123312

§ 371 Date: Oct. 23, 2020

(30) Foreign Application Priority Data
Aug. 22, 2018 (CN) 201810961401.1

(51) Int. Cl. H04W 76/18; H04B 7/0413

(52) U.S. Cl. CPC H04W 76/18; H04B 7/0413

(57) ABSTRACT

The present disclosure relates to the technical field of communications and in particular to a communication method for a mobile terminal, a mobile terminal, a medium and an apparatus. The inventor has found that when a Wi-Fi component is not connected with an AP, even if the communication is carried out by using a single channel, the communication performance will not be greatly impacted and the user experience will not be affected significantly. Thus, the solution in at least some embodiments of the present disclosure is provided to indicate the Wi-Fi component to switch a communication mode from a MIMO mode to a single channel mode when determining that the Wi-Fi component is not connected with the AP.

### CROSS-REFERENCE TO RELATED APPLICATIONS

The present disclosure claims the priority of the Chinese patent application with the application date of Aug. 22, 2018, the application number of 201810961401.1, and the patent name of “Communication method for mobile terminal, mobile terminal, medium and apparatus”, which is herein incorporated by reference in its entirety.

### TECHNICAL FIELD

The present disclosure relates to the technical field of communications, and in particular to a communication method for a mobile terminal, a mobile terminal, a medium and an apparatus.

### BACKGROUND

A multiple-input multiple-out-put (MIMO) system is a technology considered for 802.11n. 802.11n is a next generation 802.11 standard which increases throughput to 100 Mbps. In addition, proprietary MIMO technology improves the performance of existing 802.11a/b/g networks. The MIMO technology refers to that multiple transmitting antennas are arranged at a transmitting end and multiple receiving antennas are arranged at a receiving end, so that a signal is sent by the multiple transmitting antennas arranged at the transmitting end and received by the multiple receiving antennas arranged at the receiving end, thereby improving communication quality. The MIMO technology takes full advantage of space resources, realizes multiple-transmission multiple-reception by means of multiple antennas, and doubles the channel capacity of a system without increasing spectrum resources and antenna transmission power.

Currently, a wireless fidelity (Wi-Fi) components of mobile terminal, such as a mobile phone, mainly uses a 2×2 (2-way send, 2-way receive) MIMO mode for communication, so that when the mobile terminal performs communication in a Wi-Fi network, Wi-Fi network performance can be greatly improved. However, since at least one path is added on an original basis, power consumption of the mobile terminal also increases correspondingly. Therefore, how to reduce the power consumption of the mobile terminal that performs communication on the basis of a Wi-Fi MIMO mode becomes a problem to be solved urgently.

### SUMMARY

At least some embodiments of the present disclosure provide a communication method for a mobile terminal, a mobile terminal, a medium and a device, so as at least to partially solve a problem of high power consumption of a mobile terminal that performs communication on the basis of a Wi-Fi MIMO mode.

In some embodiments of the present disclosure, a communication method for a mobile terminal provided, which includes that:

determining whether a wireless fidelity (Wi-Fi) component in the mobile terminal has established a connection with an access point (AP); and

when determining that the Wi-Fi component does not establish the connection with the AP, sending a first control instruction to the Wi-Fi component to indicate the Wi-Fi component to switch from a multiple-input multiple-out-put (MIMO) mode to a single-channel mode for communication.

The inventor has found that when the Wi-Fi component is not connected with the AP, even if the communication is carried out by using a single channel, the communication performance will not be greatly impacted and the user experience will not be affected significantly. Thus, the solution in at least some embodiments of the present disclosure is provided to indicate the Wi-Fi component to switch the communication mode from the MIMO mode to the single-channel mode when determining that the Wi-Fi component is not connected with the AP, thereby ensuring that the power consumption of the mobile terminal can be effectively reduced and the energy consumption of the mobile terminal is saved while the communication performance is guaranteed.

In some embodiments, determining that the Wi-Fi component does not establish the connection with the AP includes: determining that the Wi-Fi component has not initiated the connection with the AP, or determining that the Wi-Fi component is establishing the connection with the AP.

That is, in some embodiments of the present disclosure, during the process that the Wi-Fi component has not initiated the connection with the AP or the Wi-Fi component is establishing the connection with the AP, the Wi-Fi component is switched from the MIMO mode to the single-channel mode for communication, so that the power consumption of the mobile terminal can be reduced to the maximum extent.

In some embodiments, after sending the first control instruction to the Wi-Fi component, the method further includes:

when determining that the Wi-Fi component has established the connection with the AP, sending a second control instruction to the Wi-Fi component to indicate the Wi-Fi component to switch from the single-channel mode to the MIMO mode for communication.

After the Wi-Fi component is switched from the MIMO mode to the single-channel mode for communication, when the Wi-Fi component has established the connection with the AP, the Wi-Fi component is further switched back to the MIMO mode, thereby ensuring the communication performance in a Wi-Fi network.

In some embodiments of the present disclosure, a mobile terminal is further provided. The mobile terminal includes a determination component, a sending component and a wireless fidelity (Wi-Fi) component, and

the determination component is configured to determine whether the Wi-Fi component has established a connection with an access point (AP);

the sending component is configured to send a first control instruction to the Wi-Fi component when the determination component determines that the Wi-Fi component does not establish the connection with the AP; and

the Wi-Fi component is configured to switch from a MIMO mode to a single-channel mode for communication, according to the first control instruction sent by the sending component.

The sending component is configured to send the first control instruction to the Wi-Fi component when the determination component determines that the Wi-Fi component has not initiated the connection with the AP or when the determination component determines that the Wi-Fi component is establishing the connection with the AP.

The sending component is further configured to send, after sending the first control instruction to the Wi-Fi component, a second control instruction to the Wi-Fi component when the determination component determines that the Wi-Fi component has established a connection with the AP. The Wi-Fi component is further configured to switch from the single-channel mode to the MIMO mode for communication according to the second control instruction sent by the sending component.

In some embodiments of the present disclosure, a non-transitory computer storage medium is further provided. The computer storage medium stores an executable program, and the executable program is executed by a processor to implement the steps of the method above.

In some embodiments of the present disclosure, a mobile terminal is further provided, including a memory, a processor and a computer program stored in the memory, when executing the program, the processor implementing the steps of the method above.

### BRIEF DESCRIPTION OF THE DRAWINGS

In order to illustrate the technical solutions in the embodiments of the present disclosure or the related art in a more clear manner, a brief introduction will be given below to the accompanying drawings required for describing the embodiments or the prior art. Obviously, the accompanying drawings described below involve some embodiments of the present disclosure, and other accompanying drawings may also be obtained by those skilled in the art without creative efforts on the basis of the accompanying drawings.

FIG. 1 is a flowchart schematic diagram of a communication method for a mobile terminal according to a first embodiment of the present disclosure.

FIG. 2 is a flowchart schematic diagram of a communication method for a mobile terminal according to a second embodiment of the present disclosure.

FIG. 3 is a structural schematic diagram of a mobile terminal according to a third embodiment of the present disclosure.

FIG. 4 is a structural schematic diagram of a mobile terminal according to a fourth embodiment of the present disclosure.

### DETAILED DESCRIPTION

In order to make the object, the technical solution and the advantages of the present disclosure more clear, the present disclosure will be further described in detail below with reference to the accompanying drawings. Obviously, the described embodiments are some embodiments of the present disclosure, but not all the embodiments of the present disclosure. On the basis of the embodiments of the present disclosure, all the other embodiments obtained by those skilled in the art without paying any inventive labor should fall into the scope of protection of the present disclosure.

It should be noted that the terms “first” and “second” in the description and claims of the present disclosure and the described accompanying drawings are used to distinguish similar objects, and are not necessarily used to describe a specific sequence or precedence order. It should be understood that the data so used may be interchanged where appropriate so that the embodiments of the present disclosure described herein can be implemented in sequences other than those illustrated or described herein. Moreover, the terms “include” and “have” and any variations thereof are intended to cover not exclusively including, for example, processes, methods, systems, products or devices including a series of steps or elements need not be limited to those steps or elements set forth clearly, but may include other steps or elements not set forth clearly or inherent to these processes, methods, products or devices.

### First Embodiment

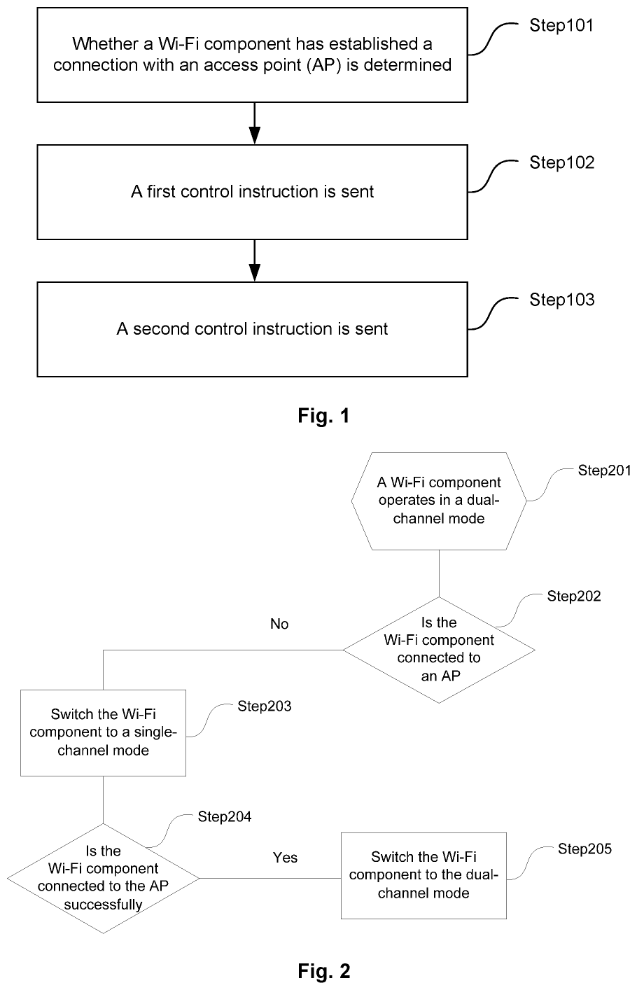

The first embodiment of the present disclosure provides a communication method for a mobile terminal. As shown in FIG. 1, the method may include the following steps.

At step 101, whether a Wi-Fi component has established a connection with an access point (AP) is determined.

An execution subject of this embodiment is the mobile terminal which performs communication on the basis of a Wi-Fi MIMO mode. It may be understood that after being powered on, the Wi-Fi component of the mobile terminal performs communication in the Wi-Fi MIMO mode by default.

In this step, it can be determined whether the Wi-Fi component has established the connection with the access point (AP). When determining that the Wi-Fi component does not establish the connection with the AP, step 102 is continued to be executed.

In some embodiments, the operation of determining that the Wi-Fi component does not establish a connection with the AP includes: determining that the Wi-Fi component has not initiated the connection with the AP, or determining that the Wi-Fi component is establishing the connection with the AP.

At step 102, a first control instruction is sent.

When determining in step 101 that the Wi-Fi component does not establish the connection with the AP, in this step, the first control instruction is sent to the Wi-Fi component to indicate the Wi-Fi component to switch from the MIMO mode to the single-channel mode for communication.

After the first control instruction is sent to the Wi-Fi component, step 101 is continued to be executed, and when determining that the Wi-Fi component has established the connection with the AP, step 103 is continued to be executed.

At step 103, a second control instruction is sent.

When determining that the Wi-Fi component has established the connection with the AP, in this step, the second control instruction is sent to the Wi-Fi component to indicate the Wi-Fi component to switch from the single-channel mode to the MIMO mode for communication.

The solution provided in the first embodiment of the present disclosure will be described below with reference to some specific examples. Each example in which the mobile terminal is a mobile phone and the MIMO mode used by the Wi-Fi component in the mobile phone is the dual-channel mode is illustrated.

### Second Embodiment

The second embodiment of the present disclosure provides a communication method for a mobile terminal. As shown in FIG. 2, the method includes the following steps.

At step 201, a Wi-Fi component operates in a dual-channel mode.

A scenario in which the Wi-Fi component operates in the dual-channel (2×2) mode is that after a mobile phone is powered on, the Wi-Fi component is enabled, the Wi-Fi component is not connected with an AP, and the Wi-Fi component operates in the dual-channel mode by default. Of course, the scenario in which the Wi-Fi component operates in the dual-channel mode is not limited to the mobile phone being powered on. In this embodiment, the scenario in which the Wi-Fi component operates in the dual-channel mode being that the mobile phone is powered on is taken as an example for illustration.

The mobile phone in this embodiment is understood as, but is not limited to, a smart phone (STA) including a Wi-Fi component.

At step 202, whether the Wi-Fi component has established a connection with the AP is determined.

In this embodiment, since the mobile phone is powered on and the Wi-Fi component has not established the connection with the AP, it can be determined that the Wi-Fi component does not establish the connection with the AP, and step 203 is continued to be executed.

Of course, when determining that the Wi-Fi component has established the connection with the AP, the dual-channel mode of the Wi-Fi component is kept unchanged.

At step 203, the Wi-Fi component is switched to a single-channel mode.

When determining that the Wi-Fi component does not establish the connection with the AP, a first control instruction is sent to the Wi-Fi component. After the Wi-Fi component receives the first control instruction, the Wi-Fi component switches from the dual-channel mode to the single-channel (1×1) mode.

At step 204, whether the Wi-Fi component has established the connection with the AP is determined.

After the Wi-Fi component is switched to the single-channel (1×1) mode, it can continue to determine whether the Wi-Fi component has established the connection with the AP. When determining that the Wi-Fi component still does not establish the connection with the AP, the single-channel mode of the Wi-Fi component is kept unchanged.

When determining that the Wi-Fi component performs frame interaction with the AP in the single-channel mode and completes the connection with the AP, step 205 is continued to be executed.

At step 205, the Wi-Fi component is switched to the dual-channel mode.

When determining that the connection between the Wi-Fi component and the AP is completed, in this step, a second control instruction is sent to the Wi-Fi component. The Wi-Fi component switches from the single-channel mode to the dual-channel mode according to the second control instruction.

It should be noted that determining whether the Wi-Fi component has established the connection with the AP and sending an instruction to the Wi-Fi component can both be understood as being implemented by means of a mobile phone software layer. Before the Wi-Fi component is successfully connected with the AP (which is understood as a router device), the mobile phone software layer sends an instruction to the Wi-Fi component to switch the Wi-Fi component to the single-channel mode. And after the switching is successful, when the mobile phone software layer receives a connection success instruction and confirms that the Wi-Fi component is successfully connected with the router device, the mobile phone software layer sends an instruction to the Wi-Fi component to switch the Wi-Fi component to the dual-channel mode.

According to the solution provided in this embodiment, for a mobile phone supporting MIMO, before the Wi-Fi component of the mobile phone is successfully connected with the AP, the Wi-Fi component uses the single-channel mode, and after the Wi-Fi component is connected with the AP, the Wi-Fi component restores the dual-channel mode. When the mobile phone is in a standby state and has not initiated a connection with the router device (not sending a probe request frame), the Wi-Fi component receives a Beacon frame in the network environment over a single channel, which can achieve the effect of power saving. Moreover, during the process of the mobile phone being connected with the router device, the Beacon frame is received and various low-speed frames are sent, the use of a single channel has almost no impact on the user experience and communication effect for connection and the Wi-Fi component can save approximately 50% of electricity.

On the basis of the same inventive concept as the first embodiment and the second embodiment, the following devices are provided.

### Third Embodiment

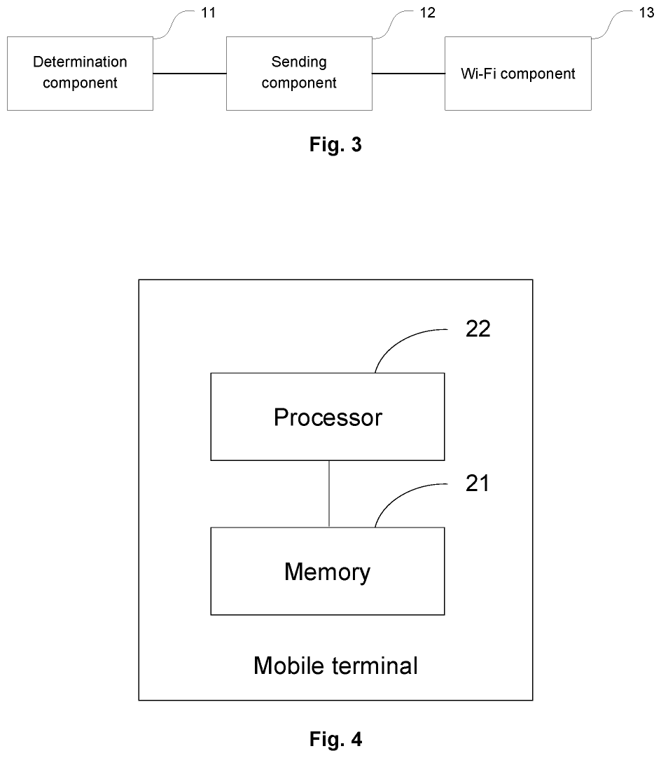

The third embodiment of the present disclosure provides a mobile terminal. As shown in FIG. 3, the structure of the device includes a determination component 11, a sending component 12 and a wireless fidelity (Wi-Fi) component 13.

The determination component 11 is configured to determine whether the Wi-Fi component has established a connection with an access point (AP). The sending component 12 is configured to send a first control instruction to the Wi-Fi component when the determination component determines that the Wi-Fi component does not establish the connection with the AP. The Wi-Fi component 13 is configured to switch from a MIMO mode to a single-channel mode for communication according to the first control instruction sent by the sending component.

The sending component 12 is configured to send the first control instruction to the Wi-Fi component when the determination component determines that the Wi-Fi component has not initiated the connection with the AP, or when the determination component determines that the Wi-Fi component is establishing the connection with the AP.

The sending component 12 is further configured to send, after sending the first control instruction to the Wi-Fi component, a second control instruction to the Wi-Fi component when the determination component determines that the Wi-Fi component has established the connection with the AP. The Wi-Fi component 13 is further configured to switch from the single-channel mode to the MIMO mode for communication according to the second control instruction sent by the sending component.

On the basis of the same inventive concept, the following device and media are provided in the embodiments of the present disclosure.

### Fourth Embodiment

The fourth embodiment of the present disclosure provides a mobile terminal. As shown in FIG. 4, the structure of the device includes a memory 21, a processor 22 and a computer program stored in the memory. When executing the program, the processor 22 implements the steps of the methods described in the first embodiment and the second embodiment of the present disclosure.

Optionally, the processor 22 includes a central processing unit (CPU) and an application specific integrated circuit (ASIC), is at least one integrated circuit for controlling program execution, is a hardware circuit developed by using a field programmable gate array (FPGA), and is a baseband processor.

Optionally, the processor 22 includes at least one processing core.

Optionally, the memory 21 includes a read-only memory (ROM), a random access memory (RAM), and a magnetic disk memory. The memory 21 is configured to store data required for the operation of at least one processor 22. There may be at least one memory 21.

The fifth embodiment of the present disclosure provides a non-transitory computer storage medium. The computer storage medium stores an executable program, and when being executed by a processor, the executable program implements the methods provided in the first embodiment and the second embodiment of the present disclosure.

In practical implementations, the computer storage medium includes various storage media that can store program codes, such as a universal serial bus flash drive (USB), a mobile hard disk, a read-only memory (ROM), a random access memory (RAM), a magnetic disk or an optical disk.

In the embodiments of the present disclosure, it should be understood that the disclosed devices and methods may be implemented in other manners. For example, the apparatus embodiments described above are merely illustrative. For example, the division of an element is a logical function division. In actual implementations, there may be another division manner, for example, multiple elements or components may be combined, or may be integrated into another system, or some features may be ignored or not executed. In addition, the mutual coupling or direct coupling or communication connection shown or discussed may be an indirect coupling or communication connection through some interfaces, devices or elements, and may be electrical or otherwise.

The various functional elements in the embodiments of the present disclosure may be integrated in one processing element, or each element may also be an independent physical component.

The integrated element, when implemented in the form of a software functional element and sold or used as a stand-alone product, can be stored in a computer-readable storage medium. On the basis of such understanding, all or some of the technical solutions of the embodiments of the present disclosure may be embodied in the form of a software product. The computer software product is stored in a storage medium, and includes several instructions to enable a computer apparatus (which may be a personal computer, a server, a network device, or a processor, etc., for example) to execute all or some of the steps of the methods described in the respective embodiments of the present disclosure. The foregoing storage medium includes: various media that can store program codes, such as a universal serial bus flash drive, a mobile hard disk, a ROM, a RAM, a magnetic disk, or an optical disk.

Those skilled in the art should understand that the embodiments of the present disclosure may be provided as a method, a system or a computer program product. Therefore, the present disclosure may employ the form of complete hardware embodiments, complete software embodiments, or embodiments combining software and hardware. Moreover, the present disclosure may employ the form of a computer program product implemented on at least one computer-usable storage media (including, but not limited to, a magnetic disk memory, a CD-ROM, an optical memory, etc.) including computer-usable program codes therein.

The present disclosure is described with reference to the flowcharts and/or block diagrams of the method, device (system) and computer program product of the embodiments of the present disclosure. It should be understood that computer program instructions may be employed to implement each process and/or block in a flowchart and/or a block diagram and a combination of processes and/or blocks in the flowchart and/or the block diagram. These computer program instructions may be provided for a processor of a general-purpose computer, a special-purpose computer, an embedded processor or other programmable data processing devices to produce a machine, such that the instructions executed by the processor of the computer or other programmable data processing devices produce an apparatus for implementing functions specified in at least one process of a flowchart and/or at least one block of a block diagram.

These computer program instructions may also be stored in a computer-readable memory that can direct a computer or other programmable data processing devices to operate in a particular manner, such that the instructions stored in the computer-readable memory produce a product including an instruction device, the instruction device implementing functions specified in at least one flow of a flowchart and/or at least one block of a block diagram.

These computer program instructions may also be loaded onto the computer or other programmable data processing devices, such that a series of operation steps are performed on the computer or the other programmable devices to produce processing implemented by the computer so that the instructions executed on the computer or the other programmable devices provide steps for implementing the functions specified in at least one flows of a flowchart and/or at least one blocks of a block diagram.

Although the preferred embodiments of the present disclosure have been described, other variations and modifications may be made to the embodiments once those skilled in the art learn the basic creative concept. Hence, the appended claims are indented to be explained as include the preferred embodiments and all the variations and modifications falling within the scope of the present disclosure.

Obviously, those skilled in the art may make various modifications and variations to the present disclosure without departing from the spirit and scope of the present disclosure. Thus, when these modifications and variations belong to the scopes of the claims of the present disclosure and the equivalents thereof, the present disclosure also intends to include such modifications and variations.

What is claimed is:

1. A communication method for a mobile terminal, comprising:
determining whether a wireless fidelity (Wi-Fi) component in the mobile terminal has established a connection with an access point (AP); and
when determining that the Wi-Fi component does not establish the connection with the AP, sending a first control instruction to the Wi-Fi component to indicate the Wi-Fi component to switch from a multiple-input multiple-out-put (MIMO) mode to a single-channel mode for communication.

2. The method as claimed in claim 1, wherein determining that the Wi-Fi component does not establish the connection with the AP comprises: determining that the Wi-Fi component has not initiated the connection with the AP.

3. The method as claimed in claim 1, wherein after sending the first control instruction to the Wi-Fi component, the method further comprises:
when determining that the Wi-Fi component has established the connection with the AP, sending a second control instruction to the Wi-Fi component to indicate the Wi-Fi component to switch from the single-channel mode to the MIMO mode for communication.

4. (canceled)

5. (canceled)

6. (canceled)

7. A non-transitory computer storage medium, wherein the computer storage medium stores an executable program, the executable program being executed by a processor to implement the following steps;
determining whether a wireless fidelity (Wi-Fi) component in the mobile terminal has established a connection with an access point (AP); and
when determining that the Wi-Fi component does not establish the connection with the AP, sending a first control instruction to the Wi-Fi component to indicate the Wi-Fi component to switch from a multiple-input multiple-out-put (MIMO) mode to a single-channel mode for communication.

8. A mobile terminal, comprising a memory, a processor and a computer program stored in the memory, when executing the program, the processor implementing the following steps;
determining whether a wireless fidelity (Wi-Fi) component in the mobile terminal has established a connection with an access point (AP); and
when determining that the Wi-Fi component does not establish the connection with the AP, sending a first control instruction to the Wi-Fi component to indicate the Wi-Fi component to switch from a multiple-input multiple-out-put (MIMO) mode to a single-channel mode for communication.

9. The method as claimed in claim 1, wherein determining that the Wi-Fi component does not establish the connection with the AP comprises: determining that the Wi-Fi component is establishing the connection with the AP.

10. The method as claimed in claim 2, wherein after sending the first control instruction to the Wi-Fi component, the method further comprises:
when determining that the Wi-Fi component has established the connection with the AP, sending a second control instruction to the Wi-Fi component to indicate the Wi-Fi component to switch from the single-channel mode to the MIMO mode for communication.

11. The non-transitory computer storage medium as claimed in claim 7, the executable program being executed by a processor to implement the following steps:
determining that the Wi-Fi component has not initiated the connection with the AP.

12. The non-transitory computer storage medium as claimed in claim 7, the executable program being executed by a processor to implement the following steps:
determining that the Wi-Fi component is establishing the connection with the AP.

13. The non-transitory computer storage medium as claimed in claim 7, the executable program being executed by a processor to implement the following steps:
when determining that the Wi-Fi component has established the connection with the AP, sending a second control instruction to the Wi-Fi component to indicate the Wi-Fi component to switch from the single-channel mode to the MIMO mode for communication.

14. The mobile terminal as claimed in claim 8, the processor implementing the following steps:
determining that the Wi-Fi component has not initiated the connection with the AP.

15. The mobile terminal as claimed in claim 8, the processor implementing the following steps:
determining that the Wi-Fi component is establishing the connection with the AP.

16. The mobile terminal as claimed in claim 8, the processor implementing the following steps:
when determining that the Wi-Fi component has established the connection with the AP, sending a second control instruction to the Wi-Fi component to indicate the Wi-Fi component to switch from the single-channel mode to the MIMO mode for communication.
